(19) United States
(12) Patent Application Publication
(10) Pub. No.: US 2006/0238657 A1
(43) Pub. Date: Oct. 26, 2006

(54) Compact projection system

(76) Inventors: Paul Bullwinkel, Stuart, FL (US); Andrew Cartlidge, Palm Beach Gardens, FL (US)

Correspondence Address: MCHALE & SLAVIN, P.A., 2855 PGA BLVD, PALM BEACH GARDENS, FL, 33410, US

(21) Appl. No.: 11/084,595

(22) Filed: Mar. 17, 2005

(51) Int. Cl. H04N 9/31

(52) U.S. Cl. 348/744

(57) ABSTRACT

A compact video projection and viewing system for use with RMI apparatus is constructed of materials that are inert to magnetic imaging and do not cause interference with the procedure. The system uses an LCD as a source of a viewable image and an optical arrangement to magnify the image and redirect the image in a lateral path to a screen. An adjustable viewing mirror is used to capture the reflection of the screen and transfer the image to a patient.

### FIELD OF THE INVENTION

This invention relates to a video projection device for use with magnetic resonance imaging (MRI) apparatus.

### BACKGROUND OF THE INVENTION

An MRI apparatus includes an electromagnet with a bore large enough to encompass a platform upon which a patient is placed during the imaging procedure. The platform is movable along the axis of the bore to position different sized patients as necessary for optimum viewing of different portions of the body. The bore is not unlike a gun barrel and patient comfort is a major concern for magnetic resonance imaging (MRI) systems. MRI patients are required to lie for long periods of time in the very confining bore of the MRI, which often leads to claustrophobia. MRI's are also extremely noisy, to the point where hearing protection is required.

There are a variety of visual systems designed for use with MRI, for example, U.S. Pat. No. 5,414,459; U.S. Pat. No. 5,892,566; and U.S. Pat. No. 6,079,819 by the instant inventor, incorporated herein by reference.

The current art of supplying visual input to MRI patients has several deficiencies. For systems that mount on the patient's face, there are electrical safety concerns, concerns about electromagnetic interference (EMI) with the imaging process, and many patients simply find that something on their face adds to the claustrophobia.

Many of these concerns are answered by using projection systems to supply visual input to MRI patients. Such a projection system operates by projecting a video image onto a screen mounted inside the bore of the magnet; the patient uses a mirror to view the image on the screen. The projection system is mounted at the rear of the MRI so as not to interfere with operation of the MRI. This approach is acceptable as long as the patient is placed head-first into the MRI bore.

However, for MRI exams of the lower extremities, the patient is placed feet-first into the bore, so their head remains outside the bore. In these cases, a projection system mounted at the rear of the bore does not work because the patient's body blocks the view of the projection screen. If the projector is mounted at the front of the bore, the projector will interfere with operation of the MRI system. Additionally, a front-mounted projector and screen will block the operator's view of the patient, preventing proper patient monitoring.

An LCD, or similar, screen can be situated outside the bore so that a patient whose head is outside the bore can view the screen. A necessary requirement for such a screen is that sufficient eye relief (distance from the patient's eyes to the screen) must be provided for comfortable viewing.

However, such eye relief may be impossible to achieve for most MRIs, because the opening to the bore gradually tapers from the outside to the inside. For MRI scans where the patient enters the bore feet-first, the head will lie within the tapered region of the bore, and there will not be room between the patient and the bore to provide sufficient eye relief.

### SUMMARY OF THE PRESENT INVENTION

Thus, what is needed in the art is a self contained video system for MR use, that is inert to the influence of the MR, does not influence the MR imaging process, and is mounted to be placed in close proximity to the patient' eyes.

Therefore, it is an objective of this invention to provide a self contained projection system, including a projector, a screen, a viewing port, and an optical arrangement adjustably mounted in close proximity to the eyes resulting in comfortable viewing.

It is another objective of this invention to provide a video projection system wherein the optical arrangement is such that the size of the projection system is minimized to allow the system to be comfortably placed between the patient and the bore of an MR machine.

It is another objective of this invention to provide a video projection system mounted independently of the patient.

It is a further objective of this invention to provide a video projection system with a rear-mounted projector.

It is yet another objective of this invention to provide a video system in conjunction with an audio system.

### SHORT DESCRIPTION OF THE DRAWINGS

FIG. 1 is a schematic of the self contained video system of this invention showing an enclosure in phantom lines;

FIG. 2 is a representation of the optics of the system of this invention;

FIG. 3 is a schematic of the video system of this invention with a separate screen; and

FIG. 4 is a representation of the optics of a rear projection system.

### DETAILED DESCRIPTION OF THE INVENTION

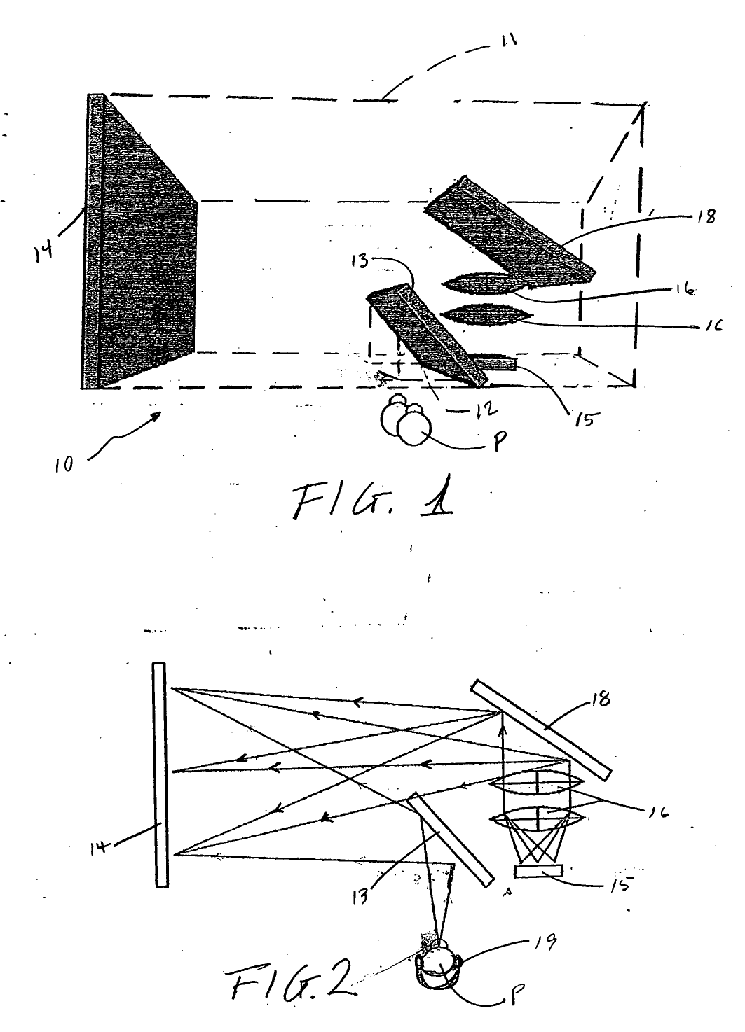

The video system 10, as shown in FIG. 1, is a self-contained unit 11 capable of being adjustably placed in close proximity to the patient P. The unit 11 may be movably connected to the MRI platform (not shown) by clamps, for example, or it may be adjustably attached to the interior of the MRI bore. The unit 11 has a viewing port 12 through which the patient can see a viewing mirror 13. Once the patient P is on the platform and in the proper position for imaging, the angle of the mirror is adjustable relative to the screen 14 to provide a view of the screen while the patient P is in a relaxed condition. Once the angle of the viewing mirror 13 is set by the patient or attendant, no other adjustments need be made to the unit 11. The separation between the screen 14, the viewing mirror 13 and the patient's eyes supplies the necessary eye relief for comfortable viewing. For example, the distance between the eye and the screen is approximately 250 mm to 300 mm, referred to as the human vision near-point.

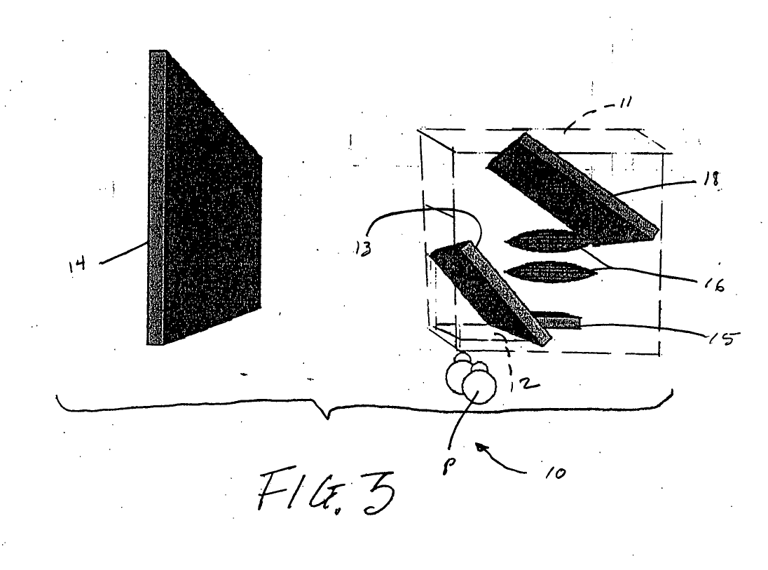

With the internal optical arrangement, shown in FIG. 2, an image is produced by the LCD display 15. Magnifying lens 16 and 17 are fixed adjacent the LCD to transmit the magnified image onto an image mirror 18. The image mirror is oriented at an angle to the lens and to the screen 14 to obtain a full screen image suitable for viewing by the patient. The screen may be backlit (not shown). Both eyes of the patient may now view a real image on the screen with no accommodation problems of focusing.

With the internal optical arrangement, shown in FIG. 2, an image is produced by the LCD display 15 in combination with a backlight 19. Magnifying lens 16 and 17 are fixed adjacent the LCD to transmit the magnified image onto an image mirror 18. The arrangement of optics is uniquely arranged to form a very compact “near-field” projector, that is, a projector designed to project over very short distances. This optical design allows a very small projector package that will comfortably fit between the patient's eyes and the MR bore.

The LCD may be activated in various ways that do not produce interference with the MRI procedure. In addition to the visual image viewed through the port 12, the patient may be provided with a coordinated audio feed by earphones 19 or speaker (not shown) carried by the unit 11.

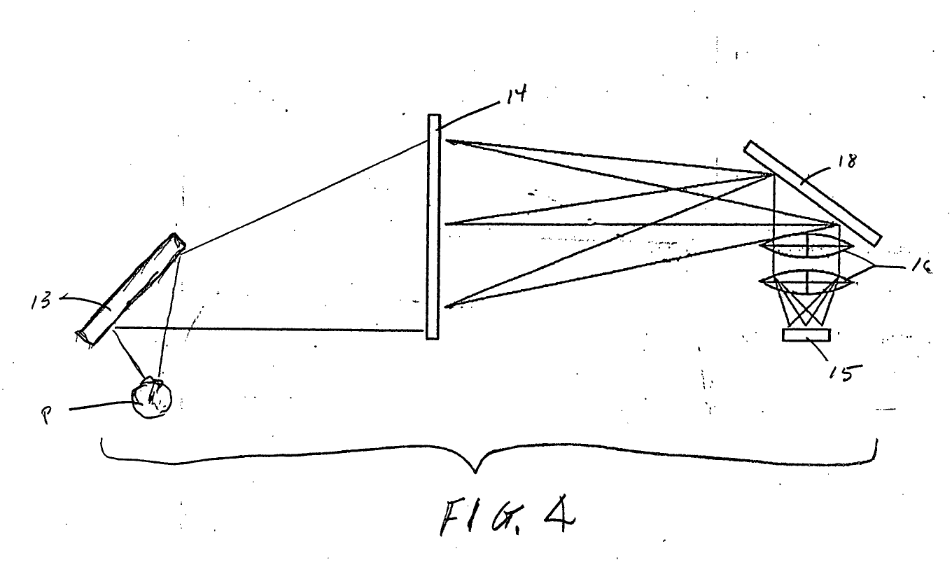

FIG. 3 illustrates another embodiment of the video system in which the screen is separately mounted from the unit 11. Both the screen 14 and the optical system may be movably installed on the MRI apparatus or one of the elements may be fixed and the other movable, for example the screen may be fixed near one end of the bore of the MRI depending on the part of the body to be imaged and the optical unit adjusted to the location of the patient's eyes.

In FIG. 4, the screen 14 is illustrated with rear projection. In this arrangement, the LCD 15 is on one side of the screen 14 and the viewing mirror 13 is on the other side. The magnified image projected on one side of the screen is visible on the other side of the screen. The video projection system may be self-contained or the screen and optical arrangement may be in an enclosure (not shown) with the viewing mirror 13 adjustably located next to the patient's eyes.

A number of embodiments of the present invention have been described. Nevertheless, it will be understood that various modifications may be made without departing from the spirit and scope of the invention. Accordingly, it is to be understood that the invention is not to be limited by the specific illustrated embodiment but only by the scope of the appended claims.

I (We) claim:

1. A video projection system for use with an MRI apparatus comprising a source of a viewable image, an optical arrangement transmitting said viewable image to a screen, and a viewing mirror adapted to reflect said viewable image from said screen to the eyes of a patient undergoing MRI imaging, said source, said optical arrangement, said screen and said mirror made of materials inert to the MRI imaging.

2. A video projection system for use with an MRI apparatus of claim 1 further comprising an enclosure surrounding and supporting said source, said optical arrangement, said screen and said mirror in operative relationship, said enclosure adapted to be adjustably mounted on the MRI apparatus.

3. A video projection system for use with an MRI apparatus of claim 2 further comprising said enclosure of a size and shape to be mounted between the eyes of a patient and the bore of an MRI apparatus.

4. A video projection system for use with an MRI apparatus of claim 1 further comprising an LCD acting as said source of said viewable image.

5. A video projection system for use with an MRI apparatus of claim 1 further comprising at least one magnifying lens in said optical arrangement between said source and said screen adapted to enlarge said viewable image.

6. A video projection system for use with an MRI apparatus of claim 1 further comprising said viewing mirror being adjustable to acquire a view of said screen.

7. A video projection system for use with an MRI apparatus of claim 1 further comprising an audio feed operatively connected with said system adapted for providing sound to a patient undergoing MRI imaging.

8. A video projection system for use with an MRI apparatus of claim 1 further comprising an enclosure surrounding and supporting said source, said optical arrangement, and said mirror in operative relationship, said enclosure adapted to be adjustably mounted on the MRI apparatus.

9. A video projection system for use with an MRI apparatus of claim 8 further comprising said screen adapted to be mounted on said MRI apparatus in line of sight with said optical arrangement and said viewing mirror.

10. A video projection system for use with an MRI apparatus of claim 1 further comprising said screen and said viewing mirror separated by a distance approximating the near-point of human vision.

11. A video projection system for use with an MRI apparatus of claim 1 further comprising said screen disposed between said source and said viewing mirror.

12. A video projection system for use with an MRI apparatus of claim 2 further comprising said screen and said viewing mirror separated by a distance approximating the near-point of human vision.

13. A video projection system for use with an MRI apparatus of claim 12 further comprising said enclosure being of a size and shape less than the bore of an MRI apparatus.

14. A self-contained video projection system comprising an enclosure containing an optical arrangement, said optical arrangement including an LCD mounted in said enclosure for providing a viewable image, an image mirror fixed in said enclosure in line of sight with said LCD, at least one magnifying lens fixed in said enclosure between said LCD and said image mirror for enlarging said viewable image and directing said viewable image to said image mirror, said image mirror redirecting said viewable image to said screen, and a viewing mirror mounted in said enclosure adapted to acquire a reflection of said viewable image on said screen, said enclosure adapted to support said viewing mirror adjacent the eyes of a patient.

15. A self-contained video projection system of claim 14 further comprising a viewing port in said enclosure, said viewing mirror adjustably mounted in view of said port.

16. A self-contained video projection system of claim 14 further comprising said image mirror oriented at an oblique angle to said at least one magnifying lens and said screen whereby said screen is disposed laterally from said LCD.

17. A self-contained video projection system of claim 14 further comprising said viewing mirror oriented at an oblique angle to said screen whereby said screen is disposed laterally from said viewing mirror.

18. A self-contained video projection system of claim 17 further comprising said image mirror oriented at an oblique angle to said at least one magnifying lens and said screen whereby said screen is disposed laterally from said LCD.
